(19) United States
(12) Patent Application Publication
(10) Pub. No.: US 2004/0263558 A1
(43) Pub. Date: Dec. 30, 2004

(54) Liquid ejecting apparatus including built-in slide-rotator type of positive displacement pump

(75) Inventor: Tatsuya Seshimo, Nagano-Ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/787,411

(22) Filed: Feb. 27, 2004

(30) Foreign Application Priority Data
Feb. 27, 2003 (JP) 2003-51478

(51) Int. Cl. B41J 2/165

(52) U.S. Cl. 347/30

(57) ABSTRACT

The present invention is a liquid ejecting apparatus including: a head member having a nozzle and a liquid-ejecting unit that ejects liquid in the nozzle; a main controlling part that drives the liquid-ejecting unit based on ejecting data; and a capping member relatively movable between a position away from the head member and a position in contact with the head member. A suction way is communicated with an inside of the capping member, and a built-in slide-rotator type of positive displacement pump is provided in the suction way. A release mechanism can release the inside of the capping member to an atmosphere even when the capping member is in contact with the head member.

### FIELD OF THE INVENTION

This invention relates to a liquid ejecting apparatus having a head member capable of ejecting a drop of liquid from a nozzle.

### BACKGROUND OF THE INVENTION

Generally, an ink-jetting recording apparatus, which is an example of liquid ejecting apparatus, includes a recording head having a nozzle, an liquid-ejecting means for ejecting ink from the nozzle (for example, a piezoelectric vibrating member or a heat-generating member), and a main controlling part that controls the liquid-ejecting means based on recording data.

The nozzle of the recording head may be clogged with the ink. In order to prevent clogging of the nozzle with the ink, a pressure pump may be provided between an ink tank and the recording head.

However, in a manner wherein the clogging of the nozzle with the ink is prevented by means of the pressure pump, a mechanism for surely preventing leakage of the ink from connecting portions of a tube or the like that connects the pressure pump and the recording head tends to become larger. In addition, it is necessary to provide a release mechanism for returning a pressurized state to an original state.

Then, the ink is sucked from the nozzle of the recording head in order to prevent the clogging of the nozzle with the ink.

In such a mechanism, when the ink is sucked, the inside of a capping member keeps a completely sealed state in order to prevent leak-in of outside air.

On the other hand, when a printing operation has been finished and the printer is in a waiting state, or when the electric power source is OFF, the nozzle is sealed by the capping member in order to prevent an evaporation of water from the nozzle. However, in that case, the inside of the capping member has to be released to the atmosphere to such an extent that it is not completely sealed, in order for a nozzle meniscus not to collapse because of expansion/contraction of air in the inside of the capping member caused by a temperature change during the waiting state.

Specifically, for example, as shown in FIGS. 17A and 17B, a tube pump 800 comprises: a tube 810 that can be elastically deformed; and a pump wheel 802 that can crush (press) down and deform the tube 810. The pump wheel 802 has a rotary main body 802a and a pulley 802b whose position relative to the rotary main body 802a is changed via a cam mechanism 802c depending on a rotational direction of the rotary main body 802a.

As shown in FIG. 17A, when the rotary main body 802a rotates in a forward rotational direction, the pulley 802b takes a position to greatly protrude from an outside periphery of the rotary main body 802a. Then, the pulley 802b crushes and deforms the tube 801, in accordance with rotation of the rotary main body 802a. The crushed tube 801 tries to return to an original shape thereof. The returning (restoring) force is used as a sucking force.

On the other hand, as shown in FIG. 17B, when the rotary main body 802a rotates in the backward rotational direction, the pulley 802b takes a position to hardly protrude from the outside periphery of the rotary main body 802a. In that state, the pulley 802b doesn't crush nor deform the tube 801, that is, the tube 801 maintains the original shape thereof. As the state continues, the atmospheric air gradually ingresses from an open end of the tube 801 toward the inside of the capping member to generate a suitable “state sealed to some extent and released to the atmosphere” (release).

As described above, the tube pump carries out a sucking operation based on a volume change thereof, which is generated when the tube crushed by the pulley returns to the original shape because of rigidity thereof. Thus, if the rigidity of the tube changes depending on for example a temperature change, the sucking speed also may change.

In addition, in order to increase a sucked volume, it may be studied to increase a rotational speed of the pulley. However, it is ineffective for the pulley to rotate at a speed faster than that at which the deformed tube returns. Thus, the sucked volume may not be increased considerably. On the other hand, if a diameter of the tube is enlarged, the sucked volume may be increased. However, in that case, it is necessary to thicken a thickness of the tube in order to maintain the tube rigidity, which makes the sucking unit larger.

The inventor has paid attention to a built-in slide-rotator type of positive displacement pump, which is a kind of pump. The built-in slide-rotator type of positive displacement pump is capable of downsizing, and is easily optimally designed depending on a driving rotational speed and/or a required flow rate.

However, in the built-in slide-rotator type of positive displacement pump, it is impossible to communicate the inside of the pump and the atmospheric air with each other by means of a simple manner such as the above release mechanism for the tube pump. The reason is that, in the built-in slide-rotator type of positive displacement pump, an inside seal thereof can not be released, because of a structural feature thereof, even if a sliding direction of a slide-rotator is changed.

Therefore, if it is planned that the nozzle of the recording head is sealed by the capping member and a mechanism for sucking the ink by means of a built-in slide-rotator type of positive displacement pump is used, another mechanism for releasing the inside of the sealed (capping state) capping member to the atmospheric air becomes necessary.

### SUMMARY OF THE INVENTION

The present invention is made to solve the above problems, that is, the object of the present invention is to provide an ink-jetting recording apparatus wherein ink in a nozzle can be sucked by means of a built-in slide-rotator type of positive displacement pump whose optimum design is easy, widely speaking, to provide a liquid ejecting apparatus wherein ink at a nozzle can be sucked by means of a built-in slide-rotator type of positive displacement pump whose optimum design is easy.

The present invention is a liquid ejecting apparatus comprising: a head member having a nozzle and a liquid-ejecting unit that ejects liquid in the nozzle; a main controlling part that drives the liquid-ejecting unit based on ejecting data; a capping member relatively movable between a position away from the head member and a position in contact with the head member; a suction way communicated with an inside of the capping member; a built-in slide-rotator type of positive displacement pump provided in the suction way; and a release mechanism that can release the inside of the capping member to an atmosphere when the capping member is in contact with the head member.

According to the present invention, the liquid in the nozzle can be sucked by means of the built-in slide-rotator type of positive displacement pump whose optimum design is easy, while the inside of the capping member can be released to the atmosphere.

The release mechanism is, for example, a release valve provided in the capping member.

If the built-in slide-rotator type of positive displacement pump has a pump frame connected to the suction way, it is preferable that the release mechanism is a release valve provided in the pump frame.

Alternatively, it is preferable that the release mechanism is a snakelike capillary way provided in the capping member.

Herein, if precision of components (parts) of the built-in slide-rotator type of positive displacement pump is low, when a sucking operation is stopped, a liquid seal in the pump may be broken down at a time so that an atmospheric release may be advanced too fast. In such a case, air bubbles may ingress the capping member and the nozzles to remarkably deteriorate liquid-ejecting performance of the head member. In the case, it is preferable to provide a check valve between the capping member and the built-in slide-rotator type of positive displacement pump (however, in the case, the manner to provide a release valve in the pump frame of the built-in slide-rotator type of positive displacement pump can not be adopted).

The built-in slide-rotator type of positive displacement pump means any pump including: a casing member, at least one rotator consisting of one or more parts, and a power transfer device for rotating the rotator, wherein a pump action is achieved by volume change caused by rotation of the rotator in the casing member. For example, the built-in slide-rotator type of positive displacement pump may be any gear pump, any roots pump, any quimby screw pump, any vane pump, or the like.

In addition, the concept of the present invention can be also applied to cases using a reciprocating-mechanism type of positive displacement pump instead of the built-in slide-rotator type of positive displacement pump. That is, the invention is a liquid ejecting apparatus comprising: a head member having a nozzle and a liquid-ejecting unit that ejects liquid in the nozzle; a main controlling part that drives the liquid-ejecting unit based on ejecting data; a capping member relatively movable between a position away from the head member and a position in contact with the head member; a suction way communicated with an inside of the capping member; a reciprocating-mechanism type of positive displacement pump provided in the suction way; and a release mechanism that can release the inside of the capping member to an atmosphere when the capping member is in contact with the head member.

According to the present invention, the liquid in the nozzle can be sucked by means of the reciprocating-mechanism type of positive displacement pump whose optimum design is easy, while the inside of the capping member can be released to the atmosphere.

The release mechanism is, for example, a release valve provided in the capping member.

The reciprocating-mechanism type of positive displacement pump may be any piston pump, any bellows pump, any diaphragm pump, or the like.

### BRIEF DESCRIPTION OF THE DRAWINGS

FIG. 1 is a schematic perspective view of an ink-jetting recording apparatus of an embodiment according to the invention;

FIG. 2A is a schematic view for explaining a scanning range of a recording head when the printer conducts a single-direction recording operation;

FIG. 2B is a schematic view for explaining a scanning range of a recording head when the printer conducts a double-direction recording operation;

FIGS. 3A to 3D are schematic views for explaining a movement of the recording head: FIG. 3A shows a state wherein the recording head being located at a waiting position; FIG. 3B shows a state wherein the recording head being moved from the waiting position to an objective recording area; FIG. 3C shows a state wherein the recording head being moved back from the objective recording area to the waiting position; and FIG. 3D shows a state wherein the recording head being located at a home position;

FIGS. 4A and 4B are schematic sectional views showing a capping member in the embodiment: FIG. 4A shows a state wherein a release valve is opened; and FIG. 4B shows a state wherein the release valve is closed;

FIGS. 5A to 5C are views showing an example of structure of a gear pump: FIG. 5A is a perspective view of a gear pump; FIG. 5B is an exploded view of the gear pump; and FIG. 5C is a partial sectional view of the gear pump;

FIG. 6 is a view for explaining a structure of a head unit included in the recording head of the embodiment;

FIG. 7 is a schematic block diagram showing an electric structure of the recording head of the embodiment;

FIG. 8 is a schematic sectional view showing a capping member in another embodiment;

FIG. 9 is a schematic sectional view showing a capping member in further another embodiment;

FIGS. 10A to 10C are views showing an example of structure of a roots pump: FIG. 10A is a perspective view of a roots pump; FIG. 10B is an exploded view of the roots pump; and FIG. 10C is a plan view of the roots pump from which a lid is removed;

FIGS. 11A to 11C are views showing an example of structure of a quimby screw pump: FIG. 11A is a perspective view of a quimby screw pump; FIG. 11B is an exploded view of the quimby screw pump; and FIG. 11C is a partial sectional view of the quimby screw pump;

FIGS. 12A to 12C are views showing an example of structure of a vane pump: FIG. 12A is a perspective view of a vane pump; FIG. 12B is an exploded view of the vane pump; and FIG. 12C is a plan view of the vane pump from which a lid is removed;

FIGS. 13A and 13B are schematic sectional views showing an embodiment wherein a check valve is provided between a capping member and a pump frame: FIG. 13A shows a state wherein a release valve is opened; and FIG. 13B shows a state wherein the release valve is closed;

FIG. 14 is a view showing an example of structure of a piston pump;

FIG. 15 is a view showing an example of structure of a bellows pump;

FIG. 16 is a view showing an example of structure of a diaphragm pump; and

FIGS. 17A and 17B are views for explaining a release of a tube pump: FIG. 17A shows a state wherein the pump is operating; and FIG. 17B shows a released state.

### BEST MODE FOR CARRYING OUT THE INVENTION

Embodiments of the invention will now be described with reference to drawings.

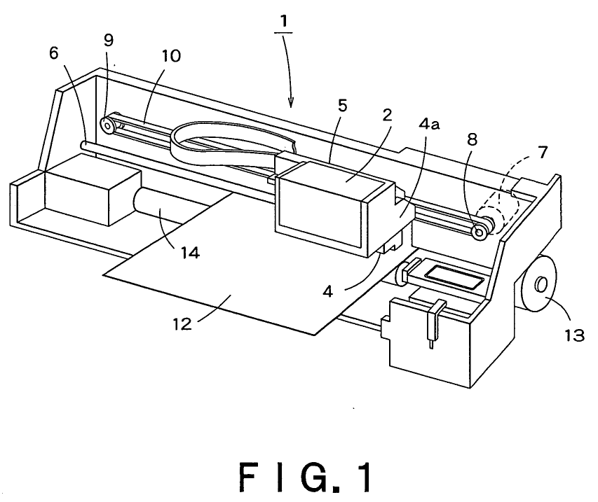

As shown in FIG. 1, an ink-jetting recording apparatus (an example of liquid ejecting apparatus)of an embodiment according to the invention is an ink-jetting printer 1. The ink-jetting printer 1 includes a carriage 5 supporting a recording head 4 (head member) that has a cartridge holder 4a capable of holding an ink cartridge 2 (liquid container). The carriage 5 is adapted to be reciprocated in a main scanning direction by a head-scanning mechanism.

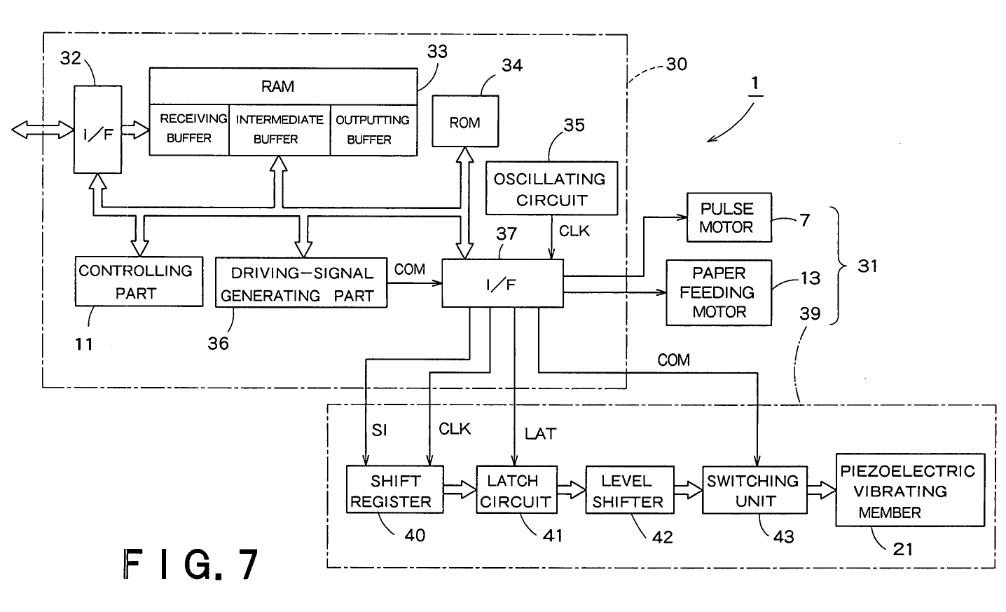

The head-scanning mechanism is formed by: a guide bar 6 laterally provided in a housing, a pulse motor 7 arranged at the housing on one side, a driving pulley 8 connected to a rotational shaft of the pulse motor 7 to be driven thereby, a free pulley 9 mounted at the housing on the other side, a timing belt 10 connected to the carriage 5 and going around the driving pulley 8 and the free pulley 9, and a controller 11 (see FIG. 7) for controlling rotation of the pulse motor 7. Thus, the carriage 5 i.e. the recording head 4 can be reciprocated in the main scanning direction i.e. in a width direction of a recording paper 12, by driving the pulse motor 7.

The printer 1 includes a paper feeding mechanism for feeding the recording paper 12 or any other recording medium (a medium onto which liquid is ejected) in a feeding direction (sub-scanning direction). The paper feeding mechanism consists of a paper feeding motor 13, a paper feeding roller 14 or the like. The recording paper 12, which is an example of a recording medium, is fed in turn, in cooperation with the recording operation.

The printer 1 of the embodiment is adapted to conduct a recording operation when the recording head 4 is moved forth (single-direction recording).

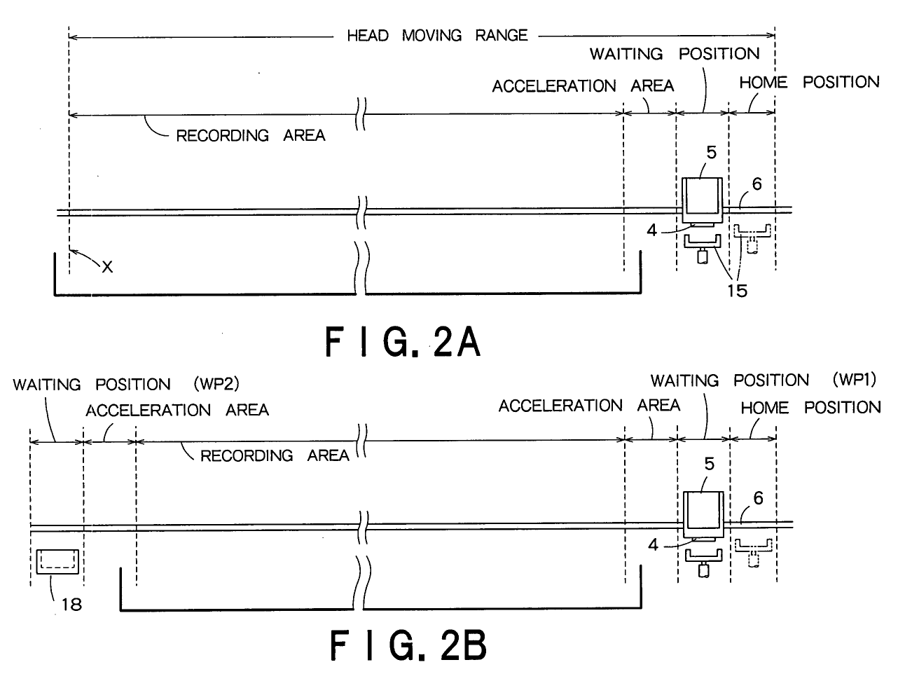

A home position and a waiting position of the recording head 4 (carriage 5) are set in a scanning range of the carriage 5 and in an end area outside an objective recording area. As shown in FIG. 2A, the home position is set at an end portion (a right end portion in FIG. 2A) in the scanning range of the recording head 4. The waiting position is set substantially adjacently to the home position on a side of the objective recording area.

This invention can be applied to a printer that is adapted to conduct a recording operation when the recording head 4 is moved back as well as when the recording head 4 is moved forth (double-direction recording). In such a printer, as shown in FIG. 2B, a second waiting position WP2 may be set at an opposite end portion with respect to a home position, in addition to a first waiting position WP1 substantially adjacent to the home position.

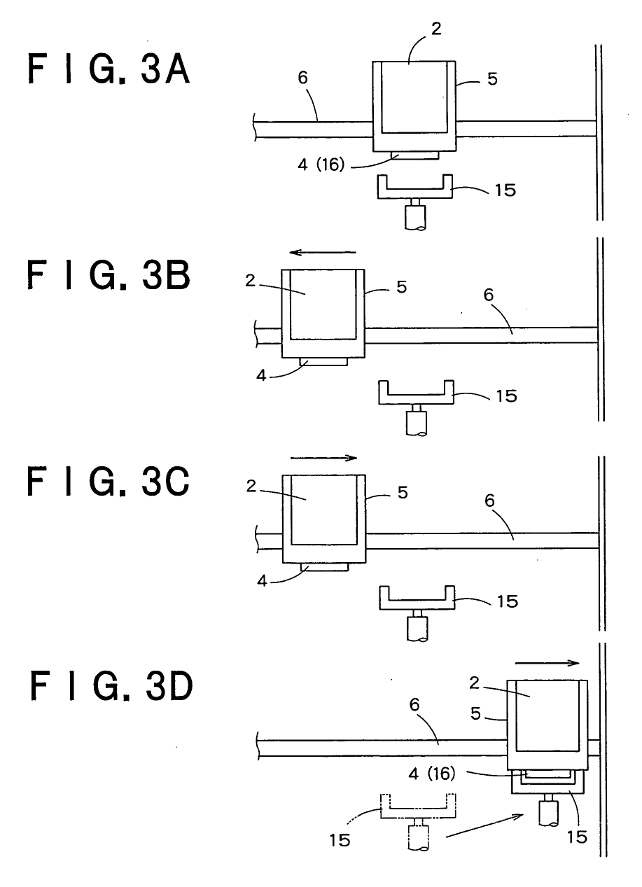

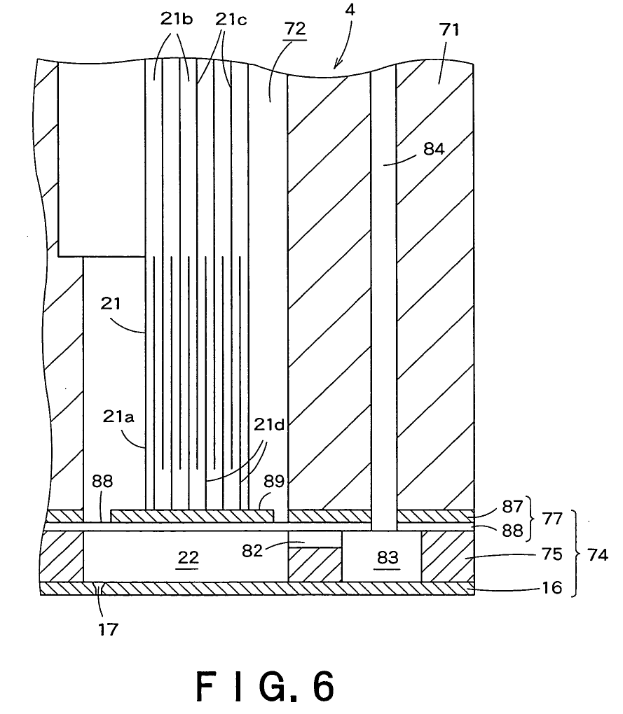

The home position is a position that the recording head 4 is moved to and stays at when electric power supply is off or when a long time has passed since the last recording operation. When the recording head 4 stays at the home position, as shown in FIG. 3D, a capping member 15 of the capping mechanism comes in contact with a nozzle plate 16 (see FIG. 6) and substantially seals nozzles 17 (see FIG. 6), which is described below in detail. The capping member 15 is a tray-like member having a substantially square shape, being open upward, and made of an elastic material such as a rubber. A moisture retaining material such as felt is attached inside the capping member 15. When the recording head 4 is sealed by the capping member 15, an inside of the capping member 15 is kept in high humid condition. Thus, it can be inhibited that solvent of the ink evaporates from the nozzles 17.

The waiting position is a starting position for moving the recording head 4 in the main scanning direction. That is, normally, the recording head 4 stays and waits at the waiting position. When a recording operation is started, the recording head 4 is moved from the waiting position to the objective recording area. Then, when the recording operation is completed, the recording head 4 is moved back to the waiting position.

In a case of the printer for the double-direction recording, with reference to FIG. 2B, the recording head 4 is moved forth from the first waiting position WP1 to the second waiting position WP2 to carry out a recording operation during moved forth. When the recording operation is completed, the recording head 4 stays and waits at the second waiting position WP2. Then, the recording head 4 is moved back from the second waiting position WP2 to the first waiting position WP1 to carry out a recording operation during moved back. When the recording operation is completed, the recording head 4 stays and waits at the first waiting position WP1. After that, the recording operation during moved forth and the recording operation during moved back are repeated in turn.

An ink-receiving member may be arranged under the waiting position in order to collect ink discharged from the recording head 4 because of flushing operations (a kind of maintenance operations). In the embodiment, the capping member 15 functions as such an ink-receiving member. That is, as shown in FIG. 3A, the capping member 15 is usually located at a position under the waiting position of the recording head 4 (a little apart from the nozzle plate 16). Then, when the recording head 4 is moved to the home position, as shown in FIG. 3D, the capping member 15 is also moved diagonally upward to the home position and to the nozzle plate 16 in order to seal the nozzles 17.

In the case of the printer for the double-direction recording, as shown in FIG. 2B, a second ink-receiving member 18 may be arranged under the second waiting position WP2. The second ink-receiving member 18 may be a flushing box open upward i.e. toward the recording head 4.

In addition, in the embodiment, an acceleration area is set between the waiting position and the objective recording area. The acceleration area is an area for raising a scanning velocity of the recording head 4 to a predetermined velocity.

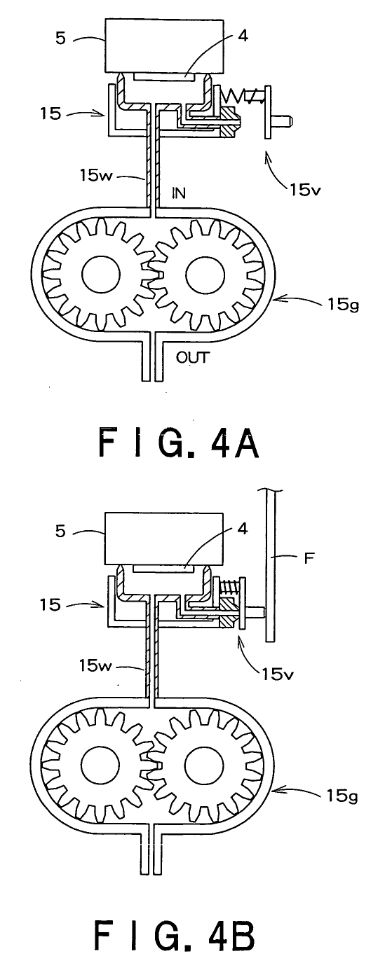

Herein, as shown in FIGS. 4A and 4B, a suction way 15w is extended from the capping member 15 of the embodiment. The suction way is communicated with the inside of the capping member 15. A gear pump 15g for sucking is provided on the way of the suction way 15w. In the case, the gear pump 15g is formed in such a precise manner that a gap between a gear and a pump frame (casing) is not more than 100 micron in both a radial direction and a thickness direction.

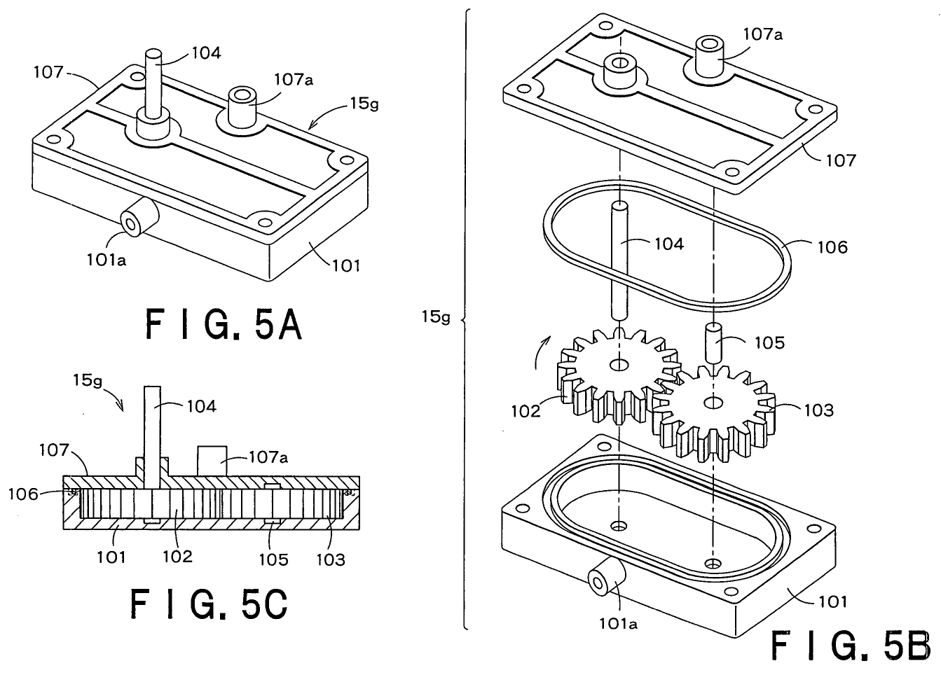

An example of structure of the gear pump 15g is explained in detail with reference to FIGS. 5A to 5C. FIG. 5A is a perspective view of the gear pump 15g, FIG. 5B is an exploded view of the gear pump 15g, and FIG. 5C is a partial sectional view of the gear pump 15.

As shown in FIGS. 5A to 5C, the gear pump 15g includes: a pump frame (casing) 101 having a suction port 101a connected to the suction way 15w; and a driving gear 102 and a driven gear 103 that are engaged with each other and slidably contained in the pump frame 101 with the above precision (via liquid menisci). The driving gear 102 is rotated by means of a driving gear shaft 104 that pierces the pump frame 101 and/or a lid 107. The driven gear 103 is pivotally supported by the pump frame 101 and the lid 107 via a driven gear shaft 105 that is parallel to the driving gear shaft 104. The pump frame (casing) 101 is sealed by the lid 107 via a packing 106. In the example, the lid 107 has a discharging port 107a. The suction port 101a and the discharging port 107a are located opposite with respect to a slide area between the gears 102, 103 and the pump frame 101.

When the driving gear 102 is rotated in a direction shown by an arrow in FIG. 5B by the driving gear shaft 104, the driven gear 103 engaged with the driving gear 102 is also rotated, so that the ink is conveyed from an IN area in the pump frame 101 (on the side of the suction port 101a) to an OUT area therein (on the side of the discharging port 107a) to achieve a pump function.

Herein, in the gear pump 15g, the seal at the engaging area and the casing area can not be released, even if the rotational direction of the gears is changed. That is, it is impossible for the In area and the OUT area to be communicated with each other to achieve an atmospheric release. Therefore, the capping member 15 of the embodiment has a release-valve mechanism 15v that is normally open. The release-valve mechanism 15v has a small diameter. As shown in FIG. 4B, the release-valve mechanism 15v is adapted to close only when the capping member 15 comes in contact with a frame F or the like, correspondingly to when it is necessary to suck the ink.

Thus, the inside of the capping member 15 is normally communicated with the atmosphere, so that it is prevented the menisci are broken down by temperature change or the like, while the capping member 15 is suitably sealed when the ink has to be sucked.

Next, the inside mechanism of the recording head 4 is explained. The recording head 4 has: a black head unit capable of jetting a drop of black ink, a cyan head unit capable of jetting a drop of cyan ink, a magenta head unit capable of jetting a drop of magenta ink, a yellow head unit capable of jetting a drop of yellow ink, a light cyan head unit capable of jetting a drop of light cyan ink, and a light magenta head unit capable of jetting a drop of light magenta ink. Each head unit has a bottom surface on which the nozzles 17 are formed in the sub-scanning direction. The number of the nozzles 17 for each head unit is common, so that the nozzles 17 of the respective head units are also aligned in the main scanning direction.

Next, the head units are explained with reference to FIG. 6. The head units have a common structure. As shown in FIG. 6, the head unit has a plastic box-like case 71 defining a housing room 72. The longitudinal-mode piezoelectric vibrating unit 21 has a shape of teeth of a comb, and is inserted in the housing room 72 in such a manner that points of teeth-like portions 21a of the piezoelectric vibrating unit 21 are aligned at an opening of the housing room 72. A ink-way unit 74 is bonded on a (lower) surface of the case 71 on the side of the opening of the housing room 72. The points of the teeth-like portions 21a are fixed at predetermined positions of the ink-way unit 74 to function as piezoelectric vibrating members respectively.

The piezoelectric vibrating unit 21 comprises a plurality of piezoelectric layers 21b. Common inside electrodes 21c and individual inside electrodes 21d are inserted alternately between each adjacent two of the piezoelectric layers 21b. The piezoelectric layers 21b, the common inside electrodes 21c and the individual inside electrodes 21d are integrated and cut into the shape of the teeth of the comb, correspondingly to dot-forming density. Thus, when a voltage is provided between the common inside electrodes 21c and an individual inside electrode 21d, a piezoelectric vibrating member contracts in a direction perpendicular to the integrated direction.

The ink-way unit 74 consists of a nozzle plate 16, an elastic plate 77 and an ink-way forming plate 75 sandwiched between the nozzle plate 16 and the elastic plate 77. The nozzle plate 16, the ink-way forming plate 75 and the elastic plate 77 are integrated.

A plurality of nozzles 17 is formed in the nozzle plate 16. A plurality of pressure generating chambers 22, a plurality of supplying ways 82 and a common chamber 83 are formed in the ink-way forming plate 75. Each of the pressure chambers 22 is defined by partition walls, and is communicated with a corresponding nozzle 17 and with a corresponding supplying way 82 at an end portion thereof. The common chamber 83 is communicated with all the supplying ways 82, and has a longitudinal shape. For example, the longitudinal common chamber 83 may be formed by an etching process when the ink-way forming plate 75 is a silicon wafer. Then, the pressure chambers 22 are formed in the longitudinal direction of the common chamber 83 at the same intervals (pitches) as nozzles 17. Then, a groove as an supplying way 82 is formed between each of the pressure chambers 22 and the common chamber 83. In the case, the supplying way 82 is connected to the end of the pressure chamber 22, while the nozzle 17 is located near the other end of the pressure chamber 22. The common chamber 83 is adapted to supply ink saved in the ink cartridge 2 to the pressure chambers 22. An supplying tube 84 from the ink cartridge is communicated with a middle portion of the common chamber 83.

The elastic plate 77 is layered on a surface of the ink-way forming plate 75 opposed to the nozzle plate 16. In the case, the elastic plate 77 consists of two laminated layers that are a stainless plate 87 and an elastic high-polymer film 88 such as a PPS film. The stainless plate 87 is provided with island portions 89 for fixing the teeth-like portions 21a as the piezoelectric vibrating members 21 in respective portions corresponding to the pressure chambers 22, by an etching process.

In the above head unit, a tooth-like portion 21a as a piezoelectric vibrating member can expand in the longitudinal direction. Then, an island portion 89 is pressed toward the nozzle plate 16, and the elastic film 88 is deformed. Thus, a corresponding pressure chamber 22 contracts. On the other hand, the tooth-like portion 21a as the piezoelectric vibrating member can contract from the expanding state in the longitudinal direction. Then, the elastic film 88 is returned to the original state owing to elasticity thereof. Thus, the corresponding pressure chamber 22 expands. By causing the pressure chamber 22 to expand and then causing the pressure chamber 22 to contract, a pressure of the ink in the pressure chamber 22 increases so that the ink drop is jetted from a nozzle 17.

That is, in the above head unit, when a tooth-like portion 21a as a piezoelectric vibrating member is charged or discharged, the volume of the corresponding pressure chamber 22 is also changed. Thus, by using the change of the volume of the pressure chamber 22, the pressure of the ink in the pressure chamber 22 can be changed, so that a drop of the ink can be jetted from the corresponding nozzle 17 or a meniscus at the corresponding nozzle 17 can be minutely vibrated. The meniscus means a free surface of the ink exposed at an opening of the nozzle 17.

Instead of the above longitudinal-mode piezoelectric vibrating unit 21, bending-mode piezoelectric vibrating members may be used. When a bending-mode piezoelectric vibrating member is used, a charging operation causes a pressure chamber to contract, and a discharging operation causes the pressure chamber to expand.

Then, an electric structure of the printer 1 is explained. As shown in FIG. 7, the ink-jetting printer 1 has a printer controller 30 and a printing engine 31.

The printer controller 30 has: an outside interface (outside I/F) 32, a RAM 33 which is able to temporarily store various data, a ROM 34 which stores a controlling program or the like, a controlling part 11 including CPU or the like, an oscillating circuit 35 for generating a clock signal, an driving-signal generating circuit 36 for generating an driving signal that is supplied into each head unit of the recording head 4, and an inside interface (inside I/F) 37 that is adapted to send the driving signal, dot-pattern-data (bit-map-data) developed according to printing data (jetting data) or the like to the print engine 31.

The outside I/F 32 is adapted to receive printing data consisting of character codes, graphic functions, image data or the like from a host computer not shown or the like. In addition, a busy signal (BUSY) or an acknowledge signal (ACK) is adapted to be outputted to the host computer or the like through the outside I/F 32.

The RAM 33 has a receiving buffer, an intermediate buffer, an outputting buffer and a work memory not shown. The receiving buffer is adapted to receive the printing data through the outside I/F 32, and temporarily store the printing data. The intermediate buffer is adapted to store intermediate-code-data converted from the printing data by the controlling part 11. The outputting buffer is adapted to store dot-pattern-data which are data for printing obtained by decoding (translating) the intermediate-code-data (for example, level data).

The ROM 34 stores font data, graphic functions or the like in addition to the controlling program (controlling routine) for carrying out various data-processing operations. The RCM 34 also stores various setting data for maintenance operations.

The controlling part 11 is adapted to carry out various controlling operations according to the controlling program stored in the RCM 34. For example, the controlling part 11 reads out the printing data from the receiving buffer, converts the printing data into the intermediate-code-data, and causes the intermediate buffer to store the intermediate-code-data. Then, the controlling part 11 analyzes the intermediate-code-data in the intermediate buffer and develops (decodes) the intermediate-code-data into the dot-pattern-data with reference to the font data and the graphic functions or the like stored in the ROM 34. Then, the controlling part 11 carries out necessary decorating operations to the dot-pattern-data, and thereafter causes the outputting buffer to store the dot-pattern-data.

When the dot-pattern-data corresponding to one line recorded by one main scanning of the recording head 4 are obtained, the dot-pattern-data are outputted to an electric driving system 39 of each head unit of the recording head 4 from the outputting buffer through the inside I/F 37 in turn. Then, the carriage 5 is moved in the main scanning direction, that is, the recording operation for the one line is conducted. When the dot-pattern-data corresponding to the one line are outputted from the outputting buffer, the intermediate-code-data that has been developed are deleted from the intermediate buffer, and the next developing operation starts for the next intermediate-code-data.

In addition, the controlling part 11 is adapted to control a maintenance operation (a recovering operation) conducted separately from the recording operation by the recording head 4.

The print engine 31 includes a paper feeding motor 13 as a paper feeding mechanism, a pulse motor 7 as a head scanning mechanism, and an electric driving system 39 of the recording head 4.

Then, the electric driving system 39 of the recording head 4 is explained. As shown in FIG. 7, the electric driving system 39 includes shift registers 40, latch circuits 41, level shifters 42 and switching units 43 and the piezoelectric vibrating members 21, which are electrically connected in the order. The shift registers 40 correspond to the respective nozzles 17, the latch circuits 41 correspond to the respective nozzles 17, the level shifters 42 correspond to the respective nozzles 17, and the switching units 43 correspond the respective nozzles 17, respectively. In addition, the piezoelectric vibrating members 21 also correspond to the respective nozzles 17 of the recording head 4, respectively.

In the electric driving system 39, when a selecting datum supplied to a switching unit 43 is “1”, the switching unit 43 is closed (connected) and the driving signal is directly supplied to a corresponding piezoelectric vibrating member 21. Thus, the piezoelectric vibrating member 21 deforms according to the signal-waveform of the driving signal. On the other hand, when a selecting datum supplied to a switching unit 43 is “0”, the switching unit 43 is opened (unconnected) and the driving signal is not supplied to a corresponding piezoelectric vibrating member 21.

As described above, based on the selecting data, the driving signal may be selectively supplied to each piezoelectric vibrating member 21. Thus, dependently on given selecting data, a drop of the ink may be jetted from a nozzle 17 or a meniscus of ink may be caused to minutely vibrate.

Next, an operation of the printer 1 is explained.

When electric power is supplied to the printer 1, a necessary initializing operation is conducted at first. Then, the recording head 4 waits at the waiting position. When printing data corresponding to one line is outputted from the outputting buffer of the RAM 33, the recording head 4 conducts a maintenance operation (recovering operation) before a recording operation for the one line.

The maintenance operation is conducted for keeping ability of the recording head 4 to jet drops of the ink. The maintenance operation may be suitably selected from an ink-sucking operation, a flushing operation, a minutely-vibrating operation, and so on.

If the ink-sucking operation is conducted, as shown in FIG. 4B, the release-valve mechanism 15v is closed by the frame F or the like to seal the inside of the capping member 15, and thereafter the gear pump 15g is caused to operate. Then, the ink is sucked from the nozzles 17 of the recording head 4 by the gear pump 15g.

After the maintenance operation is conducted, the recording operation is conducted based on the printing data. Specifically, while the recording head 4 is moved in the main scanning direction, drops of the ink can be jetted from the nozzles 17 at respective suitable timings.

As described above, according to the embodiment, the ink at the nozzles 17 can be sucked by the gear pump 15g that can be easily designed optimally. On the other hand, the inside of the capping member 15 is communicated with the atmosphere via the release-valve mechanism 15v that is normally open, so that it is prevented that the menisci of the ink be broken down by air expansion/contraction caused by the temperature change or the like.

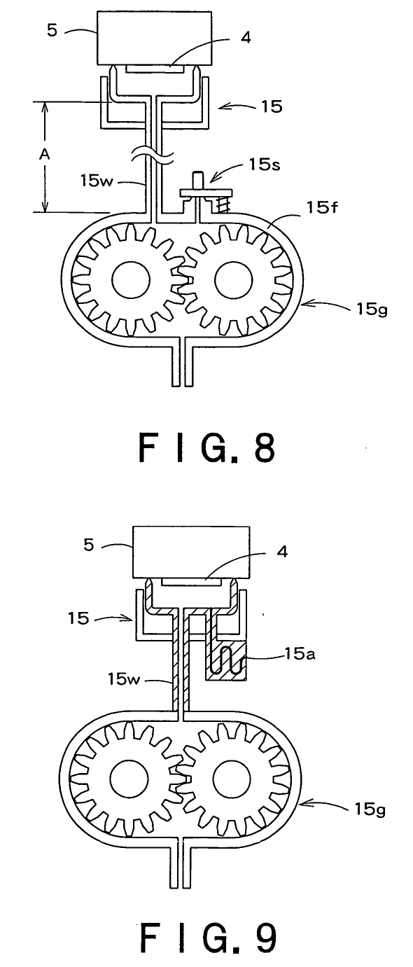

Next, FIG. 8 is a schematic sectional view showing a capping member 15 in another embodiment of the invention. No release-valve mechanism 15v is provided in the capping member 15 shown in FIG. 8. A solenoid valve 15s is provided in the pump frame 15f of the gear pump 15g on the side of the capping member 15. The other structure is substantially the same as the above embodiment explained with reference to FIGS. 1 to 7.

In the embodiment, the ink at the nozzles 17 can be sucked by the gear pump 15g that can be easily designed optimally. On the other hand, the inside of the capping member 15 is communicated with the atmosphere when the solenoid valve 15s is operated, so that it is prevented that the menisci of the ink be broken down by air expansion/contraction caused by the temperature change or the like. In particular, since the valve 15s is arranged away from the inside of the capping member 15 by a sufficient distance of the way, an evaporation of water from the capping member can be prevented.

The solenoid valve 15s may be provided not only in the pump frame 15f of the gear pump 15g, but also on the way of the suction way 15w extending from the capping member 15. In addition, the solenoid valve 15s may be replaced with another known valve mechanism.

FIG. 9 is a schematic sectional view showing a capping member 15 in further another embodiment of the invention. In the embodiment, the capping member 15 has a snakelike capillary way 15a communicated to the atmosphere, instead of the release-valve mechanism 15v. The snakelike capillary way 15a is thin enough and long enough.

That is, in the embodiment, via the capillary way 15a, the inside of the capping member 15 is always released to the atmosphere. However, since the capillary way 15a is thin enough and long enough, it has a high passage resistance. Thus, when the inside of the capping member is sucked, the atmospheric air may be drawn into the inside of the capping member through the capillary way 15a to some extent, but the volume of the air is very small and negligible. In addition, since a temperature change of the air can not be generated rapidly, the function of the atmospheric releasing can be expected sufficiently.

The other structure is substantially the same as the above embodiment explained with reference to FIGS. 1 to 8.

According to the above embodiment as well, the ink at the nozzles 17 can be sucked by the gear pump 15g that can be easily designed optimally. On the other hand, the inside of the capping member 15 can be communicated with the atmosphere, so that it is prevented that the menisci of the ink be broken down by air expansion/contraction caused by the temperature change.

Herein, the gear pump is used in the above embodiments. However, instead of the gear pump, any roots pump, any quimby screw pump, any vane pump, or any other built-in slide-rotator type of positive displacement pump may be used.

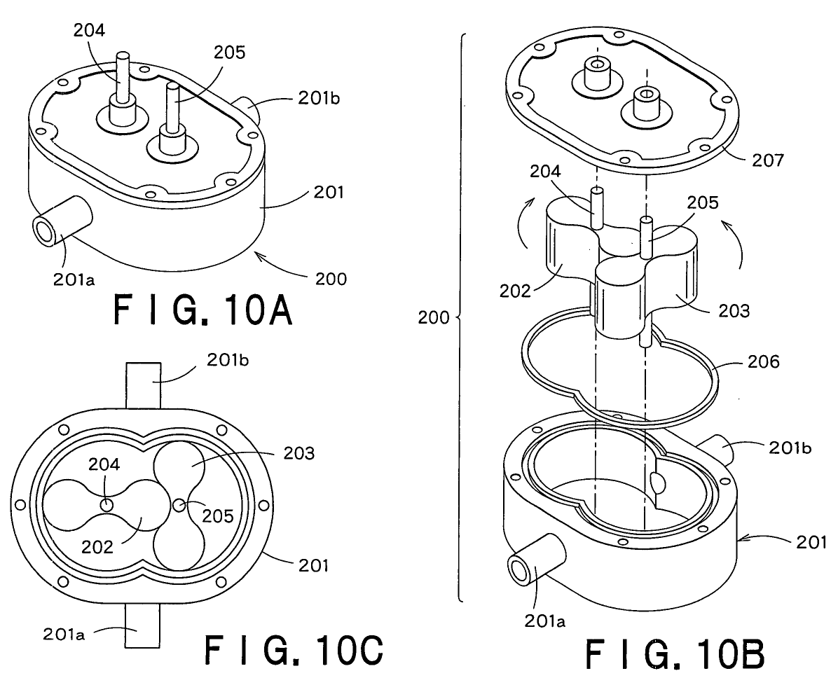

An example of structure of a roots pump is explained in detail with reference to FIGS. 10A to 10C. FIG. 10A is a perspective view of a roots pump 200, FIG. 10B is an exploded view of the roots pump 200, and FIG. 10C is a plan view of the roots pump 200 from which a lid 207 is removed.

As shown in FIGS. 10A to 10C, the roots pump 200 includes: a pump frame (casing) 201 having a suction port 201a connected to the suction way 15w; and a first rotator 202 and a second rotator 203 that are in a rolling contact with each other and that are contained in the pump frame 201. The first rotator 202 is rotated by means of a first driving shaft 204 that pierces the pump frame 201 and/or the lid 207. Similarly, the second rotator 203 is rotated by means of a second driving shaft 205 that pierces the pump frame 201 and/or the lid 207. The first driving shaft 204 and the second driving shaft 205 are arranged in parallel. The pump frame (casing) 201 is sealed by the lid 207 via a packing 206. In the example, the pump frame 201 has a discharging port 201b. The suction port 201a and the discharging port 201b are located opposite with respect to a slide area between the rotators 202, 203 and the pump frame 201.

For example, the roots pump 200 is formed in such a precise manner that a gap between the first and second rotators 202, 203 and the pump frame 201 is not more than 100 micron in both a radial direction and a thickness direction.

When the first rotator 202 and the second rotator 203 are synchronously rotated in a direction shown by arrows in FIG. 10B by the first driving shaft 204 and the second driving shaft 205, the first rotator 202 and the second rotator 203 slide on the pump frame 201 (via liquid menisci) while the first rotator 202 and the second rotator 203 roll on each other. Thus, the ink is conveyed from an IN area in the pump frame 201 (on the side of the suction port 201a) to an OUT area therein (on the side of the discharging port 201b) to achieve a pump function.

Herein, in the roots pump 200, the seal at the rolling area and the casing area can not be released, even if the rotational direction of the rotators is changed. That is, it is impossible for the In area and the OUT area to be communicated with each other to achieve an atmospheric release of the capping member 15. Therefore, for example, similarly to the case shown in FIGS. 4A and 4B, the release-valve mechanism 15v that is normally open may be provided at the capping member 15. The release-valve mechanism 15v is adapted to close only when the capping member 15 comes in contact with a frame F or the like, correspondingly to when it is necessary to suck the ink. Thus, the inside of the capping member 15 is normally communicated with the atmosphere, so that it is prevented the menisci are broken down by temperature change or the like, while the capping member 15 is suitably sealed when the ink has to be sucked.

The structures of the embodiments shown in FIGS. 8 and 9 may be also adopted for a case using the roots pump 200.

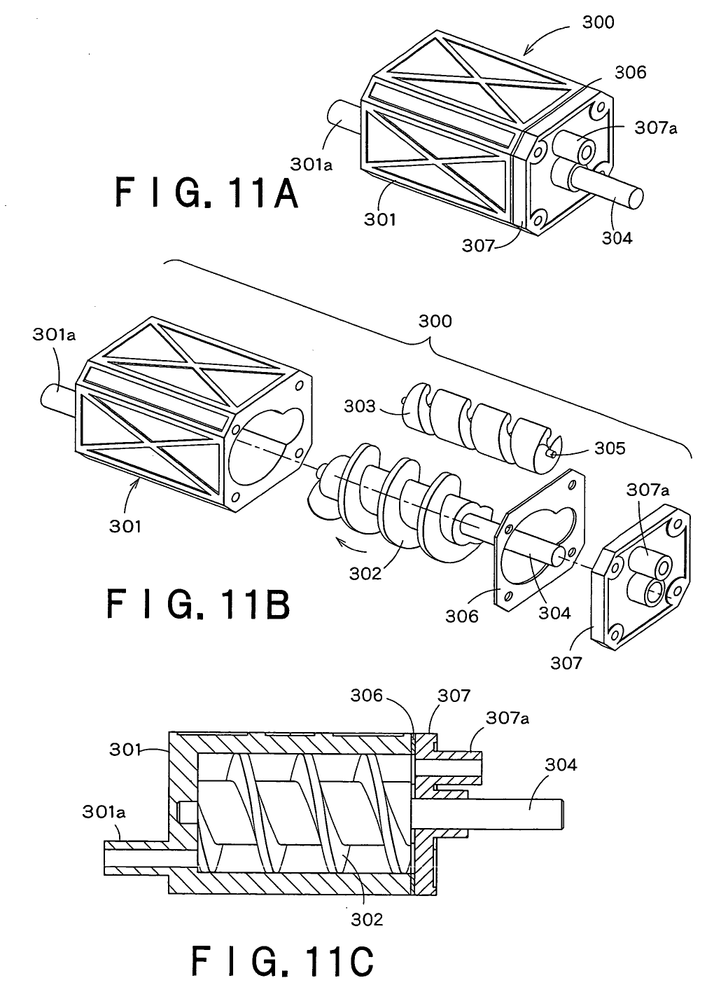

Next, an example of structure of a quimby screw pump is explained in detail with reference to FIGS. 11A to 11C. FIG. 11A is a perspective view of a quimby screw pump 300, FIG. 11B is an exploded view of the quimby screw pump 300, and FIG. 11C is a partial sectional view of the quimby screw pump 300.

As shown in FIGS. 11A to 11C, the quimby screw pump 300 includes: a pump frame (casing) 301 having a suction port 301a connected to the suction way 15w; and a driving spiral 302 and a driven spiral 303 that are engaged with each other and slidably contained in the pump frame 301 (via liquid menisci). The driving spiral 302 is rotated by means of a driving shaft 304 that pierces the pump frame 301 and/or a lid 307. The driven spiral 303 is pivotally supported by the pump frame 301 and the lid 307 via a driven shaft 305 that is parallel to the driving shaft 304. The pump frame (casing) 301 is sealed by the lid 307 via a packing 306. In the example, the lid 307 has a discharging port 307a. The suction port 301a and the discharging port 307a are located opposite with respect to a slide area between the spirals 302, 303 and the pump frame 301.

For example, the quimby screw pump 300 is formed in such a precise manner that a gap between the driving and driven spirals 302, 303 and the pump frame 301 is not more than 100 micron.

When the driving spiral 302 is rotated in a direction shown by an arrow in FIG. 11B by the driving shaft 304, the driven spiral 303 engaged with the driving spiral 302 is also rotated, so that the ink is conveyed from an IN area in the pump frame 301 (on the side of the suction port 301a) to an OUT area therein (on the side of the discharging port 307a) to achieve a pump function.

Herein, in the quimby screw pump 300, the seal at the engaging area and the casing area can not be released, even if the rotational direction of the spirals is changed. That is, it is impossible for the In area and the OUT area to be communicated with each other to achieve an atmospheric release. Therefore, for example, similarly to the case shown in FIG. 4B, the release-valve mechanism 15v that is normally open may be provided at the capping member 15. The release-valve mechanism 15v is adapted to close only when the capping member 15 comes in contact with a frame F or the like, correspondingly to when it is necessary to suck the ink. Thus, the inside of the capping member 15 is normally communicated with the atmosphere, so that it is prevented the menisci are broken down by temperature change or the like, while the capping member 15 is suitably sealed when the ink has to be sucked.

The structures of the embodiments shown in FIGS. 8 and 9 may be also adopted for a case using the quimby screw pump 300.

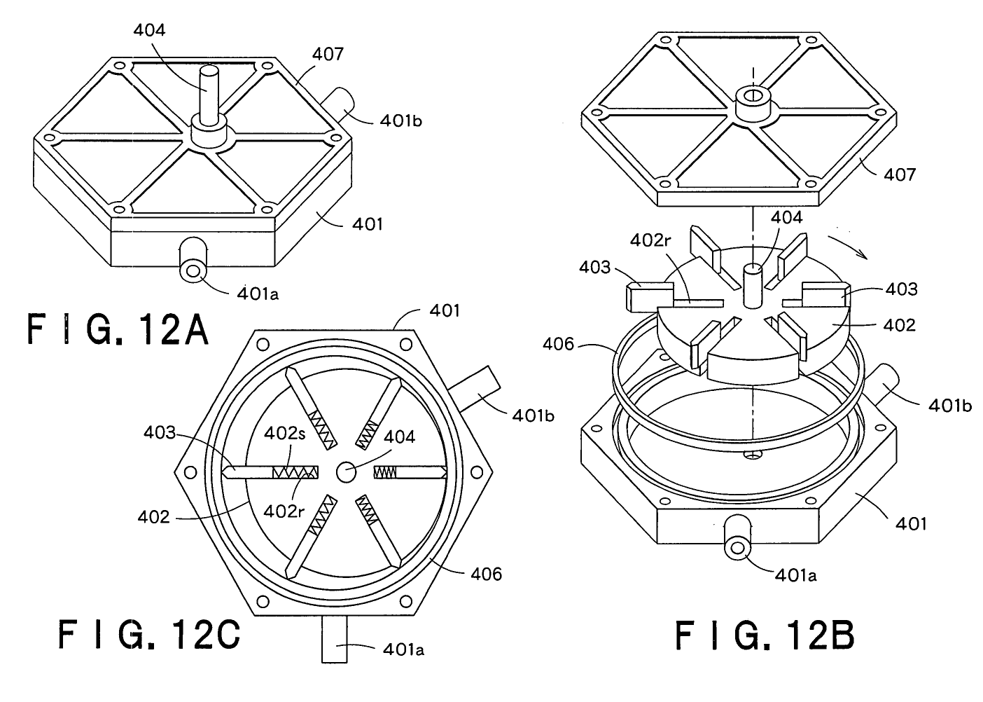

Next, an example of structure of a vane pump is explained in detail with reference to FIGS. 12A to 12C. FIG. 12A is a perspective view of a vane pump 400, FIG. 12B is an exploded view of the vane pump 400, and FIG. 12C is a plan view of the vane pump 400 from which a lid 407 is removed.

As shown in FIGS. 12A to 12C, the vane pump 400 includes: a pump frame (casing) 401 having a suction port 401a connected to the suction way 15w; and a rotor 402 that is contained in the pump frame 401. The rotor 402 has a cylindrical shape whose diameter is smaller than a diameter of a cylindrical space in the pump frame 401.

The rotor 402 is rotated by means of a driving shaft 404 that pierces the pump frame 401 and/or the lid 407. The driving shaft 404 is eccentrically located with respect to a center of the cylindrical space in the pump frame 401. A part of the outside periphery of the rotor 402 is adapted to slide on an inside surface of the pump frame 401 (via liquid menisci). A plurality of (six in the shown example) concave portions 402r is formed in the outside periphery of the rotor 402, at substantially even intervals in a circumferential direction thereof. A blade 403 is provided in each concave portion 402r via a spring 402s. The spring 402s provides a biasing force tending to move the blade 403 outwardly. The pump frame (casing) 401 is sealed by the lid 407 via a packing 406. In the example, the pump frame 401 has a discharging port 401b. The suction port 401a and the discharging port 401b are located in such a manner that a slide area between the rotor 402 and the pump frame 401 is sandwiched between the suction port 401a and the discharging port 401b.

For example, the vane pump 400 is formed in such a precise manner that a gap between the rotor 402 and the pump frame 401 is not more than 100 micron.

When the rotor 402 is rotated in a direction shown by an arrow in FIG. 12B by the driving shaft 404, by means of the blades 403 protruding from the rotor 402, the ink is conveyed from an IN area in the pump frame 401 (on the side of the suction port 401a) to an OUT area therein (on the side of the discharging port 401b) to achieve a pump function.

Herein, in the vane pump 400, the seal at the slide area can not be released, even if the rotational direction of the rotor 402 is changed. That is, it is impossible for the In area and the OUT area to be communicated with each other to achieve an atmospheric release of the capping member 15. Therefore, for example, similarly to the case shown in FIGS. 4A and 4B, the release-valve mechanism 15v that is normally open may be provided at the capping member 15. The release-valve mechanism 15v is adapted to close only when the capping member 15 comes in contact with a frame F or the like, correspondingly to when it is necessary to suck the ink. Thus, the inside of the capping member 15 is normally communicated with the atmosphere, so that it is prevented the menisci are broken down by temperature change or the like, while the capping member 15 is suitably sealed when the ink has to be sucked.

The structures of the embodiments shown in FIGS. 8 and 9 may be also adopted for a case using the vane pump 400.

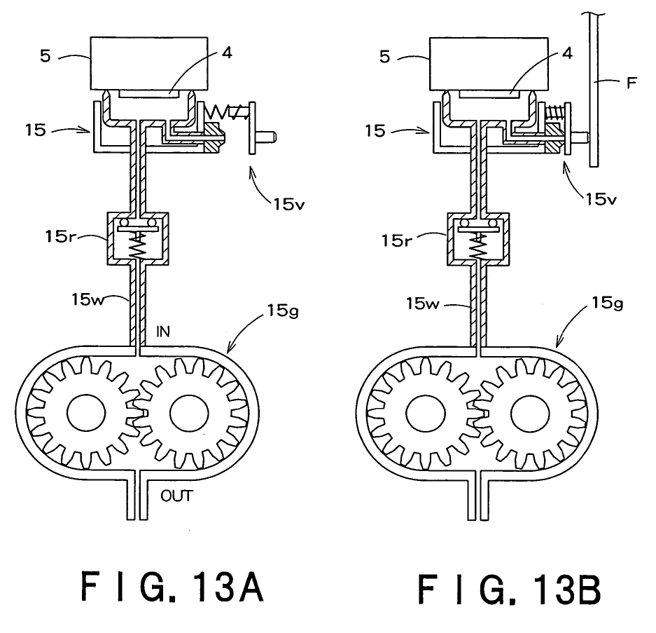

Regarding the above built-in slide-rotator type of positive displacement pumps, if precision of components thereof is low, when the sucking operation is stopped, the liquid seal in the pump may be broken down at a time so that the atmospheric release may be advanced too fast. In such a case, air bubbles may enter the capping member and the nozzles to remarkably deteriorate the ink-jetting performance of the recording head. In the case, it is preferable to provide a check valve between the capping member 15 and the built-in slide-rotator type of positive displacement pump 15g, 200, 300 or 400. An embodiment including such a check valve 15r is shown in FIGS. 13A and 13B, correspondingly to FIGS. 4A and 4B.

As clearly seen in principle, when the check valve 15r is provided, the embodiment shown in FIG. 9 can be used, but the embodiment shown in FIG. 8 can not be used.

In addition, instead of the built-in slide-rotator type of positive displacement pump like the gear pump, a reciprocating-mechanism type of positive displacement pump such as a piston pump, a bellows pump, a diaphragm pump, or the like may be also used.

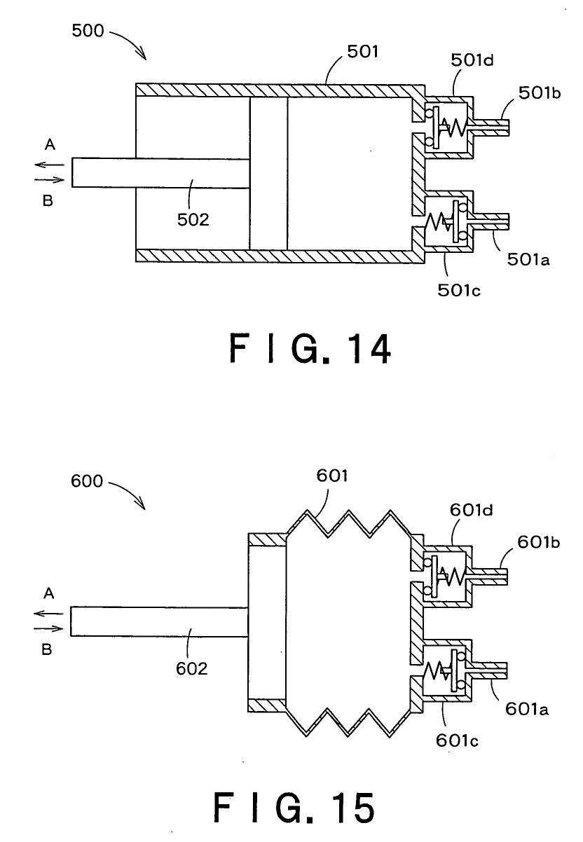

An example of structure of a piston pump is explained in detail with reference to FIG. 14. FIG. 14 is a schematic sectional view of a piston pump 500.

As shown in FIG. 14, the piston pump 500 includes a pump frame (cylinder) 501 whose volume is changeable by a reciprocating motion of a piston 502. A suction port 501a, which is connected to the suction way 15w, is formed at the pump frame 501 via a first check valve 501c. A discharging port 501b is also formed at the pump frame 501 via a second check valve 501d.

When the piston 502 is moved in a direction shown by an arrow A in FIG. 14, the ink is introduced from the suction port 501a into the pump frame 501 through the first check valve 501c. At that time, the second check valve 501d is not opened, so that the ink is not introduced back through the discharging port 501b. Then, when the piston 502 is moved in a direction shown by an arrow B in FIG. 14, the ink is conveyed from the inside of the pump frame 501 to the discharging port 501b through the second check valve 501d. At that time, the first check valve 501c is not opened, so that the ink is not conveyed back to the suction port 501a. This reciprocating motion of the piston 502 is repeated, so that the ink is conveyed from an IN area in the pump frame 501 (on the side of the suction port 501a) to an OUT area therein (on the side of the discharging port 501b) to achieve a pump function.

Herein, in the piston pump 500, it is impossible for the In area and the OUT area to be communicated with each other to achieve an atmospheric release of the capping member 15. Therefore, for example, similarly to the case shown in FIGS. 4A and 4B, the release-valve mechanism 15v that is normally open may be provided at the capping member 15. The release-valve mechanism 15v is adapted to close only when the capping member 15 comes in contact with a frame F or the like, correspondingly to when it is necessary to suck the ink. Thus, the inside of the capping member 15 is normally communicated with the atmosphere, so that it is prevented the menisci are broken down by temperature change or the like, while the capping member 15 is suitably sealed when the ink has to be sucked.

The structures of the embodiments shown in FIGS. 8 and 9 may be also adopted for a case using the piston pump 500.

Next, an example of structure of a bellows pump is explained in detail with reference to FIG. 15. FIG. 15 is a schematic sectional view of a bellows pump 600.

As shown in FIG. 15, the bellows pump 600 includes a bellows frame 601 whose volume is changeable by a reciprocating mechanism 602. A suction port 601a, which is connected to the suction way 15w, is formed at the bellows frame 601 via a first check valve 601c. A discharging port 601b is also formed at the bellows frame 601 via a second check valve 601d.

When the bellows frame 601 expands in a direction shown by an arrow A in FIG. 15, the ink is introduced from the suction port 601a into the bellows frame 601 through the first check valve 601c. At that time, the second check valve 601d is not opened, so that the ink is not introduced back through the discharging port 601b. Then, when the bellows frame 601 contracts in a direction shown by an arrow B in FIG. 15, the ink is conveyed from the inside of the bellows frame 601 to the discharging port 601b through the second check valve 601d. At that time, the first check valve 601c is not opened, so that the ink is not conveyed back to the suction port 601a. This expansion and contraction motion of the bellows frame 601 is repeated, so that the ink is conveyed from an IN area in the bellows frame 601 (on the side of the suction port 601a) to an OUT area therein (on the side of the discharging port 601b) to achieve a pump function.

Herein, in the bellows pump 600, it is impossible for the In area and the OUT area to be communicated with each other to achieve an atmospheric release of the capping member 15. Therefore, for example, similarly to the case shown in FIGS. 4A and 4B, the release-valve mechanism 15v that is normally open may be provided at the capping member 15. The release-valve mechanism 15v is adapted to close only when the capping member 15 comes in contact with a frame F or the like, correspondingly to when it is necessary to suck the ink. Thus, the inside of the capping member 15 is normally communicated with the atmosphere, so that it is prevented the menisci are broken down by temperature change or the like, while the capping member 15 is suitably sealed when the ink has to be sucked.

The structures of the embodiments shown in FIGS. 8 and 9 may be also adopted for a case using the bellows pump 600.

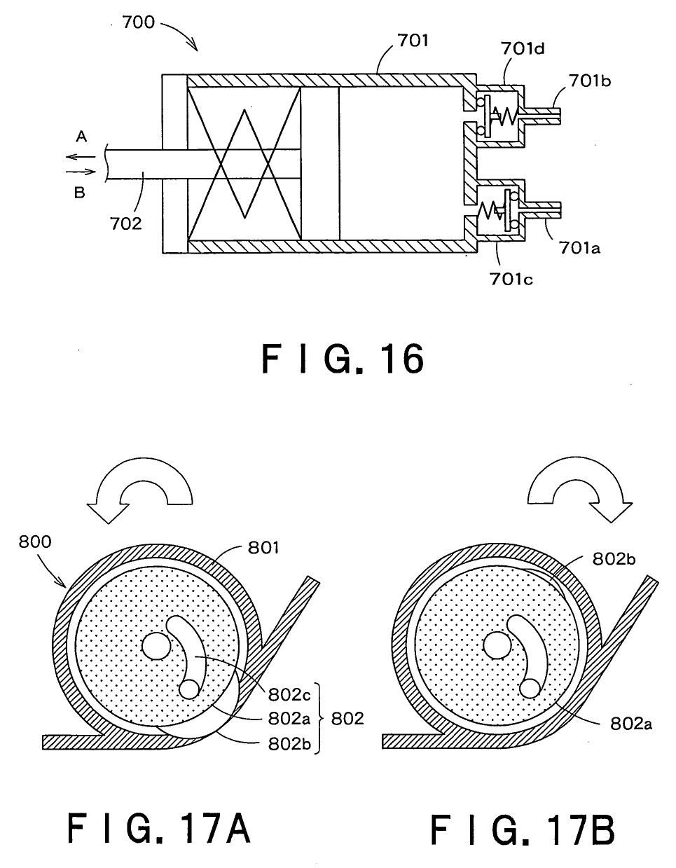

Next, an example of structure of a diaphragm pump is explained in detail with reference to FIG. 16. FIG. 16 is a schematic sectional view of a diaphragm pump 700.

As shown in FIG. 16, the diaphragm pump 700 includes a pump frame (cylinder) 701 whose volume is changeable by a reciprocating motion of a diaphragm 702. A suction port 701a, which is connected to the suction way 15w, is formed at the pump frame 701 via a first check valve 701c. A discharging port 701b is also formed at the pump frame 701 via a second check valve 701d.

When the diaphragm 702 is moved in a direction shown by an arrow A in FIG. 16, the ink is introduced from the suction port 701a into the pump frame 701 through the first check valve 701c. At that time, the second check valve 701d is not opened, so that the ink is not introduced back through the discharging port 701b. Then, when the diaphragm 702 is moved in a direction shown by an arrow B in FIG. 16, the ink is conveyed from the inside of the pump frame 701 to the discharging port 701b through the second check valve 701d. At that time, the first check valve 701c is not opened, so that the ink is not conveyed back to the suction port 701a. This reciprocating motion of the diaphragm 702 is repeated, so that the ink is conveyed from an IN area in the pump frame 701 (on the side of the suction port 701a) to an OUT area therein (on the side of the discharging port 701b) to achieve a pump function.

Herein, in the diaphragm pump 700, it is impossible for the In area and the OUT area to be communicated with each other to achieve an atmospheric release of the capping member 15. Therefore, for example, similarly to the case shown in FIGS. 4A and 4B, the release-valve mechanism 15v that is normally open may be provided at the capping member 15. The release-valve mechanism 15v is adapted to close only when the capping member 15 comes in contact with a frame F or the like, correspondingly to when it is necessary to suck the ink. Thus, the inside of the capping member 15 is normally communicated with the atmosphere, so that it is prevented the menisci are broken down by temperature change or the like, while the capping member 15 is suitably sealed when the ink has to be sucked.

The structures of the embodiments shown in FIGS. 8 and 9 may be also adopted for a case using the diaphragm pump 700.

The above description is given for the ink-jetting recording apparatus. However, this invention is intended to apply to general liquid ejecting apparatuses widely. A liquid may be glue, nail polish, conductive liquid (liquid metal) or the like, instead of the ink. Furthermore, this invention can be applied to a manufacturing unit for color filters of a display apparatus such as LCD.

What is claimed is:

1. A liquid ejecting apparatus comprising:
a head member having a nozzle and a liquid-ejecting unit that ejects liquid in the nozzle,
a main controlling part that drives the liquid-ejecting unit based on ejecting data,
a capping member relatively movable between a position away from the head member and a position in contact with the head member,
a suction way communicated with an inside of the capping member,
a built-in slide-rotator type of positive displacement pump provided in the suction way, and
a release mechanism that can release the inside of the capping member to an atmosphere when the capping member is in contact with the head member.

2. A liquid ejecting apparatus according to claim 1, wherein:
the release mechanism is a release valve provided in the capping member.

3. A liquid ejecting apparatus according to claim 1, wherein:
the built-in slide-rotator type of positive displacement pump has a pump frame connected to the suction way, and
the release mechanism is a release valve provided in the pump frame.

4. A liquid ejecting apparatus according to claim 1, wherein:
the release mechanism is a snakelike capillary way provided in the capping member.

5. A liquid ejecting apparatus according to claim 1, wherein:
a check valve is provided between the capping member and the built-in slide-rotator type of positive displacement pump.

6. A liquid ejecting apparatus according to claim 1, wherein:
the built-in slide-rotator type of positive displacement pump is a gear pump.

7. A liquid ejecting apparatus according to claim 1, wherein:
the built-in slide-rotator type of positive displacement pump is a roots pump.

8. A liquid ejecting apparatus according to claim 1, wherein:
the built-in slide-rotator type of positive displacement pump is a quimby screw pump.

9. A liquid ejecting apparatus according to claim 1, wherein:
the built-in slide-rotator type of positive displacement pump is a vane pump.

10. A liquid ejecting apparatus comprising:
a head member having a nozzle and a liquid-ejecting unit that ejects liquid in the nozzle,
a main controlling part that drives the liquid-ejecting unit based on ejecting data,
a capping member relatively movable between a position away from the head member and a position in contact with the head member,
a suction way communicated with an inside of the capping member,
a reciprocating-mechanism type of positive displacement pump provided in the suction way, and
a release mechanism that can release the inside of the capping member to an atmosphere when the capping member is in contact with the head member.

11. A liquid ejecting apparatus according to claim 10, wherein:
the release mechanism is a release valve provided in the capping member.

12. A liquid ejecting apparatus according to claim 10, wherein:
the reciprocating-mechanism type of positive displacement pump is a piston pump.

13. A liquid ejecting apparatus according to claim 10, wherein:
the reciprocating-mechanism type of positive displacement pump is a bellows pump.

14. A liquid ejecting apparatus according to claim 10, wherein:
the reciprocating-mechanism type of positive displacement pump is a diaphragm pump.
